(19) United States
(12) Patent Application Publication
(10) Pub. No.: US 2008/0055820 A1
(43) Pub. Date: Mar. 6, 2008

(54) Protective cover for personal electronic devices

(76) Inventor: William James Coleman, Green Pond, NJ (US)

Correspondence Address: LAW OFFICES OF RITA C. CHIPPERSON, 89 HEADQUARTERS PLAZA NORTH, 14TH FLOOR, SUITE 1472, MORRISTOWN, NJ, 07960, US

(21) Appl. No.: 11/509,179

(22) Filed: Aug. 24, 2006

(51) Int. Cl. H02B 1/00

(52) U.S. Cl. 361/600

(57) ABSTRACT

Disclosed are covers, as well as systems and methods for manufacturing inexpensive, throwaway covers that may be used to protect personal electronic devices from contaminants. The disclosed covers may be inexpensively manufactured using a single inexpensive raw material as well as an inexpensive manufacturing process in which no waste material is produced. In one aspect of the present invention, such covers are disposable. In another aspect of the present invention, the disclosed covers include outer and inner flaps that may be manipulated to allow the personal electronic device to be placed within the cover in either a face down or face up position. Thereafter, upon placement of the personal electronic device within the cover, the outer and inner flaps may be restored to their initial position to minimize the potential of contamination of the personal electronic device.

### BACKGROUND OF THE INVENTION

Embodiments of the present invention generally relate to aids for efficiently and effectively protecting personal electronic devices. More specifically, the present invention relates to covers, as well as systems and method for manufacturing inexpensive, throwaway covers, for use in protecting personal electronic devices from contaminants.

Disposable sleeves for covering hand-held electronic devices such as remote control units are known. One such disposable sleeve includes an opening at a first end of the sleeve through which a remote control unit may be inserted into the sleeve. The sleeve also includes an applicator for placing the sleeve over the hand-held electronic device. This applicator is designed to allow a user to apply the sleeve to the hand-held electronic device without physically touching such device.

Other disposable covers for use with cell phones are also known. One such cover has a flexible, tubular, chambered body, which is open at a first longitudinal end and includes an antenna enclosure at a second longitudinal end. The antenna enclosure varies in diameter from the main body into which the cell phone is placed. The cell phone is inserted into such cover through the first longitudinal end such that the main body of the cell phone is located within the main body of the cover and the cell phone antenna is located within the antenna enclosure. Such covers may be formed of a latex or rubber material, wherein such materials may be clear or lightly colored. Such covers are designed to protect the enclosed cell phone from its environment.

Another known protective covering for use with a cell phone or a pager is made in the form of a one-piece, resilient, water-impermeable bag. The bag includes a single opening through which the cell phone or pager may be inserted. The inwardly facing surfaces of such opening include a layer of adhesive protected by a non-adhesive strip. After the cell phone or pager has been inserted into the bag, the non-adhesive strip may be removed such that the adhesive layer is exposed. A first portion of said adhesive layer is then adhered to a second portion of said adhesive layer such that the opening is sealed in a fully closed, water-impermeable manner. This covering protects the enclosed cell phone or pager from water and other contaminants located within the surrounding environment.

Also known are phone socks for hygienically protecting a telephone receiver of a public phone, cell phone, cordless phone, or office phone. One such phone sock is shaped in the form of a telephone receiver and includes an opening therein for receiving a telephone receiver. Some such phone socks further include one or more germicidal screens to cover the ear and/or mouth portions of the telephone receiver. Such screens destroy bacteria and other germicidal agents and prevent the user from being exposed to same.

### BRIEF SUMMARY OF THE INVENTION

Briefly stated, in one aspect of the present invention, an apparatus_for protecting a personal electronic device is provided. The apparatus includes a base, an outer flap coupled to the base, an inner flap coupled to the base; and at least two ends, each of the ends coupled to the base, the outer flap, and the inner flap.

In another aspect of the present invention, a method of manufacturing a plurality of covers for protecting a personal electronic device is provided. This method includes folding a first section of a material to overlap a second section of the material, folding a third section of the material to overlap at least a portion of the first section and at least a portion of the second section, creating at least two latitudinal seals across a width of the material; and cutting the at least two latitudinal seals.

In yet another aspect of the present invention, a method of inserting a personal electronic device into a cover is provided. This method includes pulling an edge of an outer flap from an initial position in a direction away from an inner flap, sliding the personal electronic device under the inner flap; and restoring the outer flap to the initial position.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown. In the drawings:

FIG. 1 is a perspective view of a cover in accordance with one embodiment of the present invention;

FIG. 2 is a cross-sectional view of the cover of FIG. 1 taken along lines 2-2 of FIG. 1 illustrating the folded configuration of the cover;

FIG. 3A is a top plan view depicting the first step of insertion of a personal electronic device into the cover depicted in FIG. 1;

FIG. 3B is a top plan view depicting the second step of insertion of a personal electronic device into the cover depicted in FIG. 1;

FIG. 3C is a top plan view depicting the third step of insertion of a personal electronic device into the cover depicted in FIG. 1;

FIG. 4A is a perspective view of a roll of material used to manufacture covers such as the covers depicted in FIG. 1 in accordance with one embodiment of the present invention;

FIG. 4B is a cross-sectional view of an unrolled portion of the material of FIG. 4A taken along lines 4B-4B of FIG. 4A;

FIG. 4C is a top plan view of the roll of material of FIG. 4A with a portion of material unrolled and folded in accordance with one step of a process for manufacturing covers in accordance with one embodiment of the present invention;

FIG. 4D is a cross-sectional view of the folded unrolled portion of material of FIG. 4C taken along lines 4D-4D of FIG. 4C;

FIG. 4E is a top plan view of the roll of material of FIG. 4C with a second portion of the unrolled material folded in accordance with one step of a process for manufacturing covers in accordance with one embodiment of the present invention;

FIG. 4F is a cross-sectional view of the twice folded unrolled portion of material of FIG. 4E taken along lines 4F-4F of FIG. 4E;

FIG. 4G is a top plan view of the twice folded unrolled portion of material of FIG. 4E after application of latitudinal seals and cuts; and

FIG. 4H is a top plan view of an individual cover created after application of the latitudinal seals and cuts as depicted in FIG. 4G.

### DETAILED DESCRIPTION OF THE INVENTION

Certain terminology is used in the following description for convenience only and is not limiting. The words “lower” and “upper” and “top” and “bottom” designate directions in the drawings to which reference is made. The terminology includes the words above specifically mentioned, derivatives thereof and words of similar import.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a cover” includes a plurality of covers. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

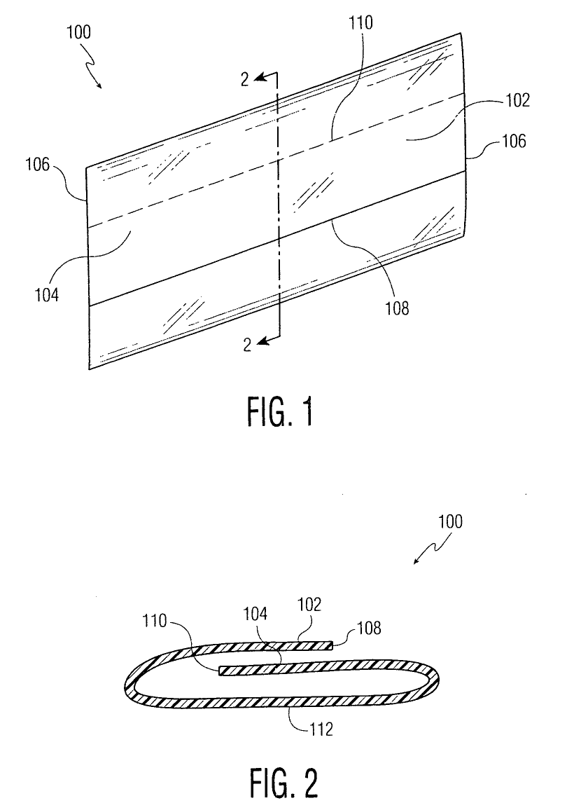

Referring first to FIG. 1, depicted is a perspective view of one embodiment of cover 100 in accordance with one embodiment of the present invention. In one aspect of the present invention, cover 100 includes outer flap 102, inner flap 104, ends 106, outer flap longitudinal edge 108, and inner flap longitudinal edge 110.

In one aspect of the present invention, cover 100 is manufactured from a flexible, chemical-resistant material. For example, in one embodiment of the present invention, cover 100 is manufactured from a polymer such as polyethylene. Use of a polymer such as polyethylene results in a clear, soft, flexible, cover 100 that is resistant to water, acids, alkalies, and a majority of solvents as well as other common contaminants such as sand, oils, paint, etc. Also, use of such a material allows covers 100 to be produced inexpensively. The inexpensive cost of covers 100 accommodates throwaway use of the covers, thereby facilitating use of such covers whenever the personal electronic device is used in a potentially contaminating environment or during a potentially contaminating activity. In either scenario, after the cover (rather than the personal electronic device contained therein) has been contaminated, it may be discarded. Then, prior to exposure of the personal electronic device to another potentially contaminating environment or prior to use of the personal electronic device during a potentially contaminating activity, a new cover may be applied thereto.

In one aspect of the present invention, such as that depicted in FIG. 1, outer and inner flaps 102 and 104, respectively, are overlapping such that they may be easily manipulated to create an aperture through which a personal electronic device may pass. This aperture allows a personal electronic device to be placed within cover 100. Such overlapping may be more easily seen in the cross-sectional view of cover 100 depicted in FIG. 2. As depicted, cover 100 includes a solid base 112, the latitudinal ends of which are folded such that outer and inner flaps 102 and 104, respectively, are created.

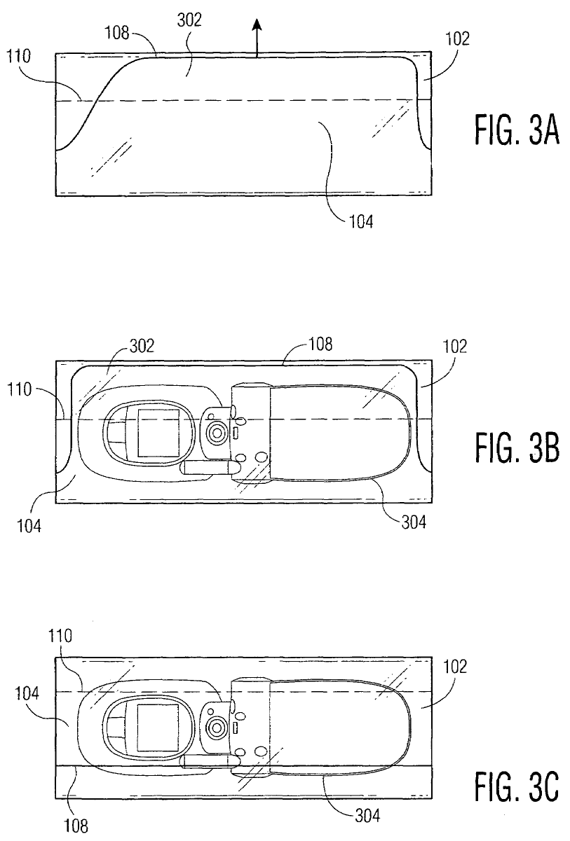

Turning next to FIG. 3A, an aperture such as aperture 302 for passing a personal electronic device therethrough may be created by latitudinally pulling outer flap longitudinal edge 108 in a direction away from inner flap 104, thereby exposing at least a portion of inner flap longitudinal edge 110. Once inner flap longitudinal edge 110 is exposed, a personal electronic device such as personal electronic device 304 may be slid underneath inner flap 104 until it is completely contained thereunder as depicted in FIG. 3B. For folding personal electronic devices such as flip top phones, it will be necessary to open, or unfold, the device prior to sliding it underneath inner flap 104. In one aspect of the present invention such as that depicted in FIGS. 3B and 3C, the personal electronic device is inserted into cover 100 face down (i.e., such that the back of the device is adjacent to outer and inner flaps 102 and 104, respectively). Such a position provides greater protection to the personal electronic device as the most sensitive areas of same (e.g., speakers, microphone, etc.) are typically located on the face of the personal electronic device. Additionally, the entire use area of the personal electronic device is protected by a continuous sheet of material, thereby minimizing the potential for contamination. Furthermore, it may be easier to view and/or operate the user interface (e.g., buttons, screens, etc.) through a continuous sheet of material as compared to layered sheets of overlapping materials. However, alternate embodiments of the present invention are envisioned in which the personal electronic device is inserted cover 100 in a face up position (i.e., such that the front of the device is adjacent to outer and inner flaps 102 and 104, respectively).

Thereafter, as depicted in FIG. 3C, outer flap 102 may be restored to its initial position, thereby minimizing and/or eliminating aperture 302 such that contaminants including without limitation chemicals, hair color, perm solution, sand, oils, paint, rain, germs, bacteria, and the like may not pass easily therethrough. This minimizes the potential that the personal electronic device will be dirtied or damaged, thereby reducing the need to perform actions such as cleaning, repairing, and replacing the personal electronic device. Covers such as cover 100 may be particularly useful in locations in which the personal electronic devices are at the highest risk of contamination including without limitation hair salons, spas, pools, beaches, hospitals, construction sites, etc. and/or for use during activities that place the personal electronic device at high risk of contamination including without limitation processing hair (e.g., coloring, perming, straightening, etc.), painting, tanning, cleaning, construction, etc.

Since the lengths of personal electronic devices may vary, cover 100 is manufactured with a length that will accommodate the length of a majority of conventional personal electronic devices. During use with shorter personal electronic devices, this may cause the cover to extend beyond the longitudinal extents of the contained personal electronic device, however, this will not prevent or decrease the level of protection provided for the personal electronic device. Although the embodiment of the present invention depicted in FIGS. 3A-3C covers a cell phone, other types of personal electronic devices including without limitation Blackberry® electronic mail devices, personal digital assistants (“PDA”), calculators, etc. may be substituted without departing from the scope of the present invention.

Covers 100 also include ends 106, which prevent contact of the personal electronic device contained within the cover with any contaminants that may be present on or external to cover 100. This minimizes the potential that the personal electronic device will be dirtied or damaged, thereby reducing the need to perform actions such as cleaning, repairing, and replacing the personal electronic device. Although ends 106 are latitudinal seals created by a processing machine such as a packaging machine, alternate ends may be substituted without departing from the scope of the present invention. For example, such ends may be formed by adhesion, glue, cinching, or any other method for sealing two ends together without departing from the scope hereof.

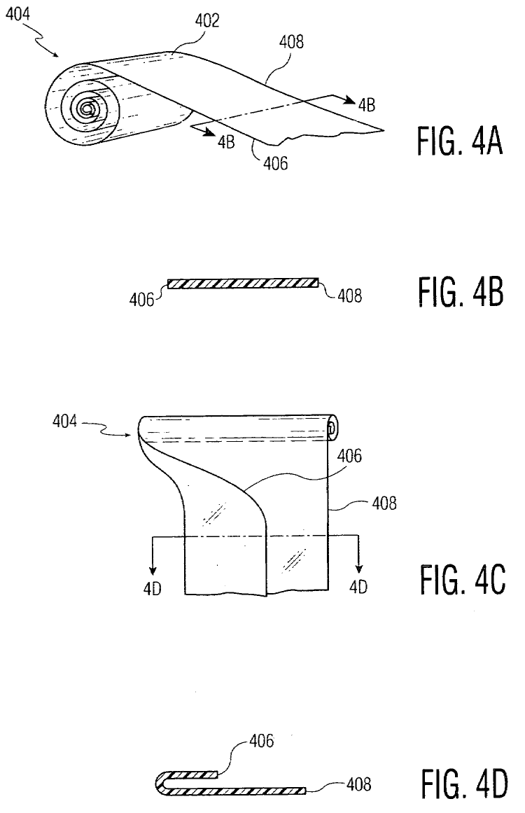

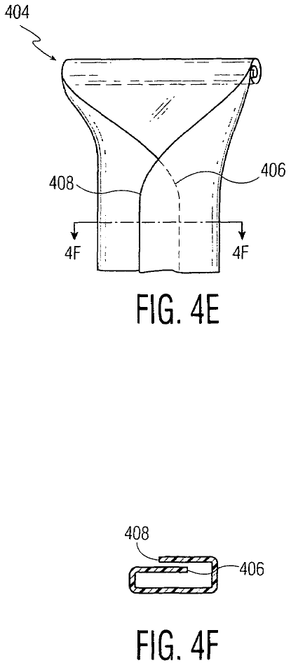

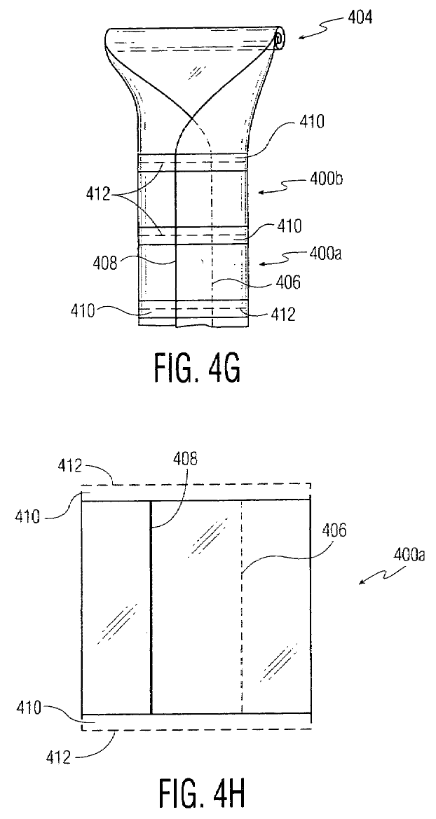

Turning next to FIGS. 4A-4H, illustrated is one method of manufacturing covers such as covers 100 in accordance with one embodiment of the present invention. Such a method reduces the cost of cover 100, as a minimal quantity of steps is required and no waste material is produced. This is an important aspect of the depicted embodiment of the present invention because it allows covers 100 to be produced inexpensively by minimizing the required quantity of raw material. However, other methods of manufacturing the covers of the present invention may be employed without departing from the scope of the present invention.

Referring now to FIG. 4A, illustrated is a perspective view of roll 404 of material 402 as formed or purchased prior to or during the beginning of the manufacturing process. In one aspect of the present invention, material 402 is a rectangular sheet of plastic (e.g., polyethylene) wound to form a roll such as roll 404. Material 402 is essentially flat as depicted in the cross-sectional view shown in FIG. 4B. In one embodiment of the present invention, material 402 has a width of approximately seven inches, however, alternate embodiments are envisioned having varying widths without departing from the scope of the present invention.

Rolling of material 402 facilitates storage of material 402 until it is fed into a processing machine such as a packaging machine. In one aspect of the present invention, the packaging machine is a plastic processing machine or a bag machine, however, other similar machines may be substituted without departing from the scope of the present invention. The rolled configuration of material 402 allows it to be fed evenly into the processing machine and allows such machine to pull the rectangular sheet of material 402 from roll 404 as it is processed as discussed below with respect to FIGS. 4C through 4H. However, although FIG. 4A depicts a step in which material 402 is wound to create roll 404, the present invention may also be made from unrolled material 402 without departing from the scope of the present invention.

In one aspect of the present invention, material 402 has a thickness of two thousandths of an inch (0.002 inch). However, materials having varying thickness may be substituted without departing from the scope of the present invention, providing that the thickness allows sufficient manipulation of outer and inner flaps such as outer and inner flaps 102 (FIG. 1) and 104 (FIG. 1), respectively, to allow a personal electronic device to be inserted into the cover. The length of material 402 is selected based upon the quantity of desired covers and the length of each individual cover.

Turning next to FIG. 4C, illustrated is a top view of the folding of a first longitudinal edge 406 of material 402 as it occurs during the next phase of the manufacturing process. Such folding occurs after a sufficient length of material 402 has been unrolled from roll 404. In one aspect of the present invention, first longitudinal edge 406 is folded such that it encompasses approximately two-thirds of the width of the resulting cover. However, first longitudinal edge 406 may be folded to varying dimensions of the resulting cover without departing from the scope of the present invention. The cross-sectional configuration of material 402 after such folding is depicted in FIG. 4D.

Turning next to FIG. 4E, illustrated is a top view of the folding of a second longitudinal edge 408 of material 402 as it occurs during the next phase of the manufacturing process. In one aspect of the present invention, second longitudinal edge 408 is folded atop first longitudinal edge 406 such that it encompasses approximately two-thirds of the width of the resulting cover. Consequently, the overlap of first and second longitudinal edges 406 and 408, respectively, equals approximately one third of the width of the resulting cover. However, second longitudinal edge 408 may be folded to varying dimensions of the resulting cover without departing from the scope of the present invention. The cross-sectional configuration of material 402 after such folding is depicted in FIG. 4F.

Referring now to FIG. 4G, illustrated is a top perspective view of latitudinally heat sealed and cut material 402 as produced in the next phase of the manufacturing process in accordance with one embodiment of the present invention. After material 402 has been folded as discussed above, the processing machine forms sequential, equally spaced latitudinal seals 410 and latitudinal cuts 412. Latitudinal seals 410 may be formed by simultaneously applying heat and pressure across the latitudinal extents of material 402 via a mechanism such as a heat seal bar. However, other mechanisms may be substituted without departing from the present invention. Furthermore, such mechanisms may optionally include a cutting mechanism for simultaneous creation of latitudinal cuts 412.

Latitudinal cuts 412 may be formed by simply slicing or otherwise cutting material 402. In one aspect of the present invention, latitudinal cuts 412 are approximately centered or are otherwise located within latitudinal seals 410 to ensure that a sufficient width of latitudinal seal 410 remains on either side of the respective latitudinal cut 412 to form a sealed end for each of the two covers partially formed via the respective latitudinal cut. That is, each latitudinal cut 412 forms a first end of a first cover such as cover 400a and a second end of a second cover 400b as depicted in FIG. 4G. The location of latitudinal cuts such as latitudinal cuts 412 relative to latitudinal seals such as latitudinal seals 410 is designed such that cutting of latitudinal cuts 412 does not disrupt or alter the integrity of the respective latitudinal seals 410. Such seals must remain intact to prevent contact of the personal electronic device contained within the cover with any contaminants that may be present on or external to cover 100.

The equidistant location of each subsequent latitudinal seal 410 and latitudinal cut 412 creates a plurality of covers 400 having equivalent lengths such as cover 400a as depicted in FIG. 4H. In one embodiment of the present invention, each latitudinal seal 410 and latitudinal cut 412 is located approximately eight inches from the previous latitudinal seal 410 and latitudinal cut 412, respectively, such that each resulting cover 400 has a length of approximately eight inches. However, alternate embodiments are envisioned having varying lengths without departing from the scope of the present invention. Furthermore, alternate embodiments of the present invention are envisioned in which latitudinal seals and/or latitudinal cuts are not equidistantly spaced, thereby creating covers of varying lengths. Furthermore, although latitudinal seals and cuts are discussed herein as two different steps, a processing machine fitted with a custom heat seal bar having cutting capabilities may be substituted to reduce these two steps to one step. Furthermore, embodiments of the present invention are envisioned in which the method of manufacturing is performed with a machine other than a packaging machine, or alternatively, such method is performed without a machine (e.g., manually) without departing from the scope of the present invention.

In embodiments of the present invention in which the width of material 402 is approximately seven inches and each of the ongitudinal edges are folded over that they overlap material 402 by approximately two inches each, the resulting width of cover 400 is approximately three inches. However, covers having varying dimensions may be substituted without departing from the scope of the present invention.

Although the method of manufacturing depicted in FIGS. 4A through 4H includes approximately four steps, any quantity of steps may be performed without departing from the scope of the present invention. For example, some steps may be eliminated (e.g., the covers may not be latitudinally cut, therefore requiring the user to manually cut them from a roll with a scissor, etc.). Or, some steps may be combined. In yet another alternate embodiment, steps or stages may be added to those disclosed herein (e.g., application of color or trademarks to the covers, application of markings to the covers, etc.) without departing from the scope of the present invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. An apparatus for protecting a personal electronic device comprising:
a base;
an outer flap coupled to said base;
an inner flap coupled to said base; and
at least two ends, each of said ends coupled to said base, said outer flap, and said inner flap.

2. An apparatus according to claim 1, wherein a material of said apparatus is selected from the group consisting of a polymer, a plastic, a polyethylene, and combinations thereof.

3. An apparatus according to claim 1, wherein said apparatus is disposable.

4. An apparatus according to claim 1, wherein said personal electronic device is at least one of the group consisting of a cell phone, a personal digital assistant, an electronic mail device, a calculator, and combinations thereof.

5. An apparatus according to claim 1, wherein said apparatus protects said personal electronic device from at least one contaminant.

6. A method of manufacturing a plurality of covers for protecting a personal electronic device comprising:
folding a first section of a material to overlap a second section of said material;
folding a third section of said material to overlap at least a portion of said first section and at least a portion of said second section;
creating at least two latitudinal seals across a width of said material; and
cutting said at least two latitudinal seals.

7. A method according to claim 6, wherein said cutting separates a first of said covers from a second of said covers.

8. A method according to claim 6, wherein each of said at least two latitudinal seals forms an end of said cover.

9. A method according to claim 6, wherein a width of said material is approximately seven inches.

10. A method according to claim 6, wherein said at least two latitudinal seals are created via application of at least one of the group consisting of heat, pressure, and combinations thereof.

11. A method according to claim 10, wherein said application of at least one of the group consisting of heat, pressure, and combinations thereof is performed via at least one of the group consisting of a heat seal bar, a packaging machine, and combinations thereof.

12. A method according to claim 6, wherein said method produces approximately zero waste.

13. An apparatus according to claim 6, wherein said material is selected from the group consisting of a polymer, a plastic, a polyethylene, and combinations thereof.

14. A method according to claim 6 further comprising:
unrolling a length of said material from a roll of said material prior to said folding, said creating, and said cutting.

15. A method according to claim 6, wherein said plurality of covers are disposable.

16. A method according to claim 6, wherein said material is at least one of the group consisting of a rectangular sheet in an unrolled form and a rectangular sheet in a rolled form.

17. An apparatus according to claim 6, wherein said personal electronic device is at least one of the group consisting of a cell phone, a personal digital assistant, an electronic mail device, a calculator, and combinations thereof.

18. A method of inserting a personal electronic device into a cover comprising:
pulling an edge of an outer flap from an initial position in a direction away from an inner flap;
sliding said personal electronic device under said inner flap; and
restoring said outer flap to said initial position.

19. A method according to claim 18, wherein said personal electronic device is slid under said inner flap in a position selected from the group consisting of face down and face up.

20. A method according to claim 18, wherein said cover is disposable.

21. A method according to claim 18, wherein said personal electronic device is at least one of the group consisting of a cell phone, a personal digital assistant, an electronic mail device, a calculator, and combinations thereof.
